(19) United States
(12) Patent Application Publication
(10) Pub. No.: US 2023/0002587 A1
(43) Pub. Date: Jan. 5, 2023

(54) BITUMINOUS COMPOSITIONS, METHODS AND USES THEREOF

(71) Applicant: TOTALENERGIES ONETECH, Courbevoie (FR)

(72) Inventors: Olivier GAMET, Bailly Romainvilliers (FR); Mouhamad MOUAZEN, Nanterre (FR); Stefan OEST, Itzehoe (DE)

(73) Assignee: TOTALENERGIES ONETECH, Courbevoie (FR)

(21) Appl. No.: 17/781,825

(22) PCT Filed: Dec. 18, 2020
(86) PCT No.: PCT/FR2020/052536

§ 371 Date: Jun. 2, 2022

(30) Foreign Application Priority Data
Dec. 20, 2019 (FR) FR1915235

(51) Int. Cl. C08K 3/22; C08K 3/013

(52) U.S. Cl. CPC C08K 3/22; C08K 3/013

(57) ABSTRACT

The present invention relates to a bituminous composition comprising a mixture:
a bitumen base, which represents at least 50% by weight, and preferably at least 80% by weight, and preferentially at least 90% by weight, of the total weight of the composition, and
a hydroxide XOH with X=Na or K, which represents from 0.001 to 1% by weight of the total weight of the composition,
   said bitumen base having an intrinsic stability S from 1 to 2.5 and/or a peptisation level Sa from 0 to 0.6, said values S and Sa being measured according to standard ASTM D 7157-12,
   as well as the method of preparation and uses thereof, particularly in the field of road construction.

### TECHNICAL FIELD

The present invention relates to the technical field of binders that can replace traditionally used bitumen compositions, particularly in the field of road construction. More specifically, the invention relates to novel bituminous compositions, methods for their preparation and their use in road and industrial applications.

Petroleum refining involves different processes and transformations. Petroleum undergoes a first distillation, called distillation under atmospheric pressure i.e. 1013.25 hPa). This first distillation step makes it possible to recover different hydrocarbon fractions (gas: butane and propane, light petroleum, heavy naphtha, kerosene, gasoil, domestic fuel, . . . ) separated according to their boiling point. Atmospheric distillation is carried out in a plate column. At the end of this distillation under atmospheric pressure, there remains a heavy residual fraction, which is called the atmospheric residue or the atmospheric distillation residue. This atmospheric residue contains long-chain hydrocarbons which, due to this, are fragile and therefore likely to be cleaved into smaller chains, if heating is carried out under atmospheric pressure. This residue therefore undergoes a second distillation under reduced pressure (commonly called vacuum distillation). The reduced pressure used for this second distillation is, in general, in the range from 10 to 150 hPa. Such reduced pressure reduces the temperature at which components evaporate, and thus allows heating to be reduced. Distillation under reduced pressure is also carried out in a plate column or packed column, or a dual system combining these two types of columns. At the end of this vacuum distillation step, there remains a heavy residual fraction, which is called the vacuum distillation residue, or the reduced pressure distillation residue.

It is always commercially interesting to transform heavy residues into light cuts which have more commercial value. This visbreaking process is applied to the vacuum distillation residues to partially transform the heavy products into light products, which also leads to reducing the viscosity of the residue obtained at the end of this visbreaking process. Visbreaking, in particular, makes it possible to recover noble molecules and to extract fuel and gasoil. Such a visbreaking process corresponds to «heat cracking» carried out, in general, in the liquid phase in the temperature range from 420° C. to 500° C., preferably a temperature from 450 to 460° C., and under pressure in the range from 5 000 to 20000 hPa. Visbreaking is carried out without provision of hydrogen. The residue obtained is called a visbroken residue.

Such a visbroken residue can, in particular, have an intrinsic stability S of less than 2.5 and/or a peptisation level Sa of less than 0.6, said values S and Sa being defined and measured according to standard ASTM D 7157-12. The visbroken residues can be added to other bitumen bases to reduce the cost in particular, due to their lower price than bitumen. On the other hand, they cannot be used alone or in large amounts as in that case it is not possible to obtain a binder that complies with the requirements of standards EN 12591 and EN 13294-1, and in particular standard EN12591, to fulfil the specific requirements of road applications (road-grade bitumen). In particular, in application WO 2015/071370, the use of an amount representing at the most 50% by weight of the bituminous composition is recommended.

The use of visbroken vacuum distillation residue is also known to be responsible for the appearance of crevices, ruptures, cracks, fissures, cracks and/or breaks in particular, which appear at a low temperature, when they are used in large amounts, in road coatings.

Within the scope of the invention, the applicant proposes novel bituminous compositions which make it possible to upgrade bitumen bases which are known not to be satisfactory, such as visbroken residues. The compositions according to the invention, in spite of such bitumen bases, have adapted resistance to ageing to act as binders, particularly in the field of road construction, and, in particular, which can be used to manufacture mixes or asphalts. An objective is also to propose such bituminous compositions which help reduces the appearance of fissures at low temperature.

The bituminous compositions according to the invention could therefore constitute a substitute for traditional bitumen compositions, which would be particularly advantageous in the case of shortages in road-grade bitumen. In addition, within the context of the decision by the World Maritime Organisation to reduce in 2020 the maximum sulphur limit in maritime fuels to 0.5% by weight, it is probable that there will be less bitumen available corresponding to available specific requirements of road construction. Indeed, bitumen would have to undergo processing which would give diesel and coke. In this context, the invention proposes substitutes for standard road bitumen and hard bitumen, which there could be a lack of over the coming years. In particular, the invention proposes substitutes for standard road bitumen which there could be a lack of over the coming years.

### INVENTION

In this context, the invention relates to bituminous compositions comprising a mixture of:
a bitumen base, which represents at least 50% by weight, and preferably at least 80% by weight, and preferentially at least 90% by weight, of the total weight of the composition, and
a hydroxide XOH with X=Na or K, which represents from 0.001 to 1% by weight, preferably from 0.002 to 0.5% by weight, and preferentially from 0.01 to 0.5% by weight of the total weight of the composition.
   said bitumen base having an intrinsic stability S from 1 to 2.5 and/or a peptisation level Sa from 0 to 0.6, said values S and Sa being measured according to standard ASTM D 7157-12.

Within the scope of the invention, the inventors have developed new bituminous compositions which, although comprising a substantial amount of a base bitumen having an intrinsic stability S from 1 to 2.5 and/or a peptisation level Sa of 0 to 0.6, show satisfactory resistance to ageing properties. In particular, the bituminous compositions according to the invention have a lower ball and ring temperature and greater maintenance of needle penetration, when they are subjected to ageing tests, compared to the bituminous base alone in said composition. In particular, the compositions according to the invention also comply with the requirements of standard EN 12591. Such a substantial improvement in the ageing properties permitting use in the road construction field of compositions containing large amounts of such a bitumen base was completely unexpected. Application WO 2018/206489 in the applicant's name did not anticipate combining a hydroxide and an aminated additive in such bitumen bases, known not to fulfil road construction requirements.

Advantageously, a composition according to the invention has one of the following characteristics, several of the following characteristics, if not all of the following characteristics:
the bitumen base is a mixture of products resulting from visbreaking of the residues of distillation under reduced pressure, said residues of distillation under reduced pressure originating from distillation under reduced pressure of atmospheric residues originating from direct atmospheric distillation of petroleum;
the composition according to the invention comprises from 0.002 to 0.5% by weight, preferably from 0.01 to 0.5% by weight of hydroxide XOH with X=Na or K, the % being % weights, relative to the total weight of the composition;
the hydroxide XOH, with X=Na or K, forms particles which have a mean maximum size in the range from 10 to 100 μm, preferably in the range from 20 to 60 μm and/or which have a maximum size less than or equal to 100 μm, preferably less than or equal to 60 μm;
the hydroxide XOH is soda;
after RTFOT ageing (at a temperature of 163° C., for 75 minutes and under air flow of 4 litres/min), according to standard EN 12607-1, the variation in the ball and ring softening temperature of said composition, determined according to standard EN 1427, is less than 8° C. and/or the maintenance of needle penetration at 25° C. of said composition, determined according to standard EN 1426, is greater than 60%;
after RTFOT ageing (at a temperature of 163° C., for 75 minutes and under air flow of 4 litres/min), according to standard EN 12607-1, the variation in the ball and ring softening temperature of said bitumen base, determined according to standard EN 1427, is greater than 8° C. and/or the maintenance of needle penetration at 25° C. of the bitumen base, determined according to standard EN 1426, is less than or equal to 60%;
after RTFOT ageing (at a temperature of 163° C., for 75 minutes and under air flow of 4 litres/min)+PAV (at a temperature of 100° C., for 20 hours and at a pressure of 2100 kPa), according to standards EN 12607-1 and EN 14769, the variation in the ball and ring softening temperature of the composition according to the invention, determined according to standard EN 1427, is less than 16° C. and/or the maintenance of needle penetration at 25° C. of said composition, determined according to standard EN 1426, is greater than 50%;
said composition has needle penetration at 25° C., determined according to standard EN 1426, which falls within the range from 5 to 80 mm/10 and/or a ball and ring softening temperature, determined according to standard EN 1427, which falls within the range from 45 to 75° C.;
after RTFOT ageing (at a temperature of 163° C., for 75 minutes and under air flow of 4 litres/min)+PAV (at a temperature of 100° C., for 20 hours and at a pressure of 2100 kPa), according to standards EN 12607-1 and EN 14769, the variation in the ball and ring softening temperature of the bitumen base according to the invention, determined according to standard EN 1427, is greater than 16° C.;
The composition comprises, moreover, according to the invention a hydrocarbonated component CH, chosen from among hydrocarbonated oils, soft-grade bitumen, fluxed bitumen, fluidified bitumen, and mixtures thereof, said hydrocarbonated component CH preferably representing at the most 10% by weight, preferentially 0.1 to 10% by weight, in a more preferred manner 0.5 to 8% by weight, and even more preferably 1 to 5% by weight, of the total weight of the composition.
the composition according to the invention comprises, moreover, an adhesion promoter, chosen from among amines, diamines, polyamines, alkyl amido amines, amidopolyamines, imidazolines, and mixtures thereof, said adhesion promoter representing 0.01 to 2% by weight, preferentially 0.05 to 1% by weight, and in an even more preferred manner 0.1 to 0.3% by weight, of the total weight of the composition.

An objective of the invention is also a method for the preparation of a bituminous composition, comprising the following steps:

a—having an initial bituminous composition available comprising a bituminous base having an intrinsic stability S from 1 to 2.5 and/or a peptisation level Sa from 0 to 0.6, said values S and Sa being defined and measured according to standard ASTM D 7157-12, and
b—incorporating a hydroxide XOH with X=Na or K, in an amount such that the amount of hydroxide XOH introduced represents 0.001 to 1% by weight, of the total weight of the final bituminous composition obtained,
the initial bituminous composition comprising an amount such that said bituminous base represents at least 50% by weight, preferably at least 80% by weight, and preferably at least 90% by weight, of the total weight of the final bituminous composition obtained.

Advantageously, within the scope of the invention, in step b, a hydrocarbonated composition IC comprising 15 to 50% by weight of hydroxide XOH with X=Na or K is incorporated into the initial bituminous composition, said composition IC, comprising a hydrocarbonated component CH, preferably chosen from among hydrocarbonated oils, soft-grade bitumen, fluxed bitumen, fluidified bitumen and mixtures thereof.

In particular, the hydroxide XOH, with X=Na or K, is present in the composition IC, in the form of particles which have a mean maximum size in the range from 10 to 100 μm, preferably in the range from 20 to 60 μm and/or which have a maximum size less than or equal to 100 μm, preferably less than or equal to 60 μm.

In general, incorporation of the hydrocarbonated composition IC into the initial bituminous composition, is carried out, at a temperature in the range from 150 to 220° C., preferably in the range from 160 to 190° C. and/or with stirring in the range from 100 to 500 rpm, preferably in the range from 200 to 400 rpm, for a period of 10 to 180 minutes, preferably from 10 to 20 minutes.

An objective of the invention is also different uses of a hydroxide XOH with X=Na or K in bitumen base representing at least 50% by weight preferably at least 80% by weight, and preferentially at least 90% by weight, of the total weight of a bituminous composition, to improve the properties of said composition. Said bitumen base is characterised by an intrinsic stability S from 1 to 2.5 and/or a peptisation level Sa from 0 to 0.6, said values S and Sa being measured according to standard ASTM D 7157-12.

In particular, the invention relates to the use of a hydroxide XOH with X=Na or K, in a bituminous composition which comprises a bitumen base having an intrinsic stability S from 1 to 2.5 and/or a peptisation level Sa from 0 to 0.6, said values S and Sa being measured according to standard ASTM D 7157-12, said bitumen base representing at least 50% by weight, preferably at least 80% by weight, and preferentially at least 90% by weight, of the total weight of the bituminous composition, in which the hydroxide XOH with X=Na or K is introduced into the bituminous composition, in an amount representing from 0.001 to 1% by weight, preferably from 0.002 to 0.5% by weight, and preferentially from 0.01 to 0.5% by weight, of the total weight of the bituminous composition, to improve resistance to ageing under RTFOT (at a temperature of 163° C., for 75 minutes under air flow of 4 litres/min) according to the standard EN 1426 and/or resistance to ageing under RTFOT (at a temperature of 163° C., for 75 minutes under air flow of 4 litres/min)+PAV (at a temperature of 100° C., for 20 hours and at a pressure of 2100 kPa) carried out according to standards EN 12607-1 and EN 14769, the % by weight given for the bitumen base and hydroxide being calculated relative to the total weight of the bituminous composition including the hydroxide.

Advantageously, the introduction of the hydroxide XOH with X=Na or K in the bituminous composition leads, after RTFOT ageing (at a temperature of 163° C., for 75 minutes under air flow of 4 litres/min), according to the standard EN 12607-1, to a variation in the ball and ring softening temperature, determined according to standard EN 1427, of less than 8° C. and/or maintenance of needle penetration at 25° C., determined according to standard EN 1426, greater than 60%.

Advantageously, the introduction of the hydroxide XOH with X=Na or K in the bituminous composition leads, after RTFOT ageing (at a temperature of 163° C., for 75 minutes under air flow of 4 litres/min)+PAV (at a temperature of 100° C., for 20 hours and at a pressure of 2100 kPa), according to the standards EN 12607-1 and EN 14769, to a variation in the ball and ring softening temperature, determined according to standard EN 1427, of less than 16° C. and/or maintenance of needle penetration at 25° C., determined according to standard EN 1426, greater than 50%.

The invention also has as an objective the use of a hydroxide XOH with X=Na or K, in a bituminous composition which comprises a bitumen base having an intrinsic stability S from 1 to 2.5 and/or a peptisation level Sa from 0 to 0.6, said values S and Sa being measured according to standard ASTM D 7157-12, said bitumen base representing at least 50% by weight, preferably at least 80% by weight, and preferentially at least 90% by weight, of the total weight of the bituminous composition, in which the hydroxide XOH with X=Na or K is introduced into the bituminous composition, in an amount representing from 0.001 to 1% by weight, preferably from 0.002 to 0.5% by weight, and preferentially from 0.01 to 0.5% by weight, of the total weight of the bituminous composition, to improve resistance to low temperatures evaluated according to standard DIN EN 14771, the % by weight given for the bitumen base and hydroxide being calculated relative to the total weight of the bituminous composition including the hydroxide.

The invention also relates to the use of a composition according to the invention for the preparation of waterproof coating, a membrane or seal layer.

A method for the preparation of a mix comprising hot mixing of a composition according to the invention, with aggregates, and possibly mineral and/or synthetic fillers, as well as a mix comprising a composition according to the invention, mixed with aggregates, and possibly mineral and/or synthetic fillers, are also an integral part of the invention.

The invention also relates to a method for the preparation of asphalt comprising hot mixing of a composition according to the invention, with mineral and/or synthetic fillers, as well as asphalts comprising a composition according to the invention, mixed with mineral and/or synthetic fillers.

An objective of the invention is also the use of a composition according to the invention, to prepare a surface coat, a hot mix, cold mix, cold-poured mix, grave-emulsion or rolling layer, said composition being associated with aggregates and/or recycled milled material.

The invention will be better understood from the detailed description which follows.

### Definitions

Within the scope of the invention, the terms «to comprise» or «to include» and their variations «comprises», «includes», «comprising», «including» do not exclude the presence of one or several elements or steps of a method other than that or those specified. Nevertheless, unless understood otherwise from the context, the terms «comprise» or «include» and variations signify «to consist exclusively of» or its corresponding variation.

Within the scope of the invention when it relates to a hydroxide XOH, this includes a single hydroxide XOH, as well as several hydroxides; when reference is made to a bitumen base having an intrinsic stability S from 1 to 2.5 and/or a peptisation level Sa from 0 to 0.6, this includes a single bitumen base, as well as one or several bitumen bases having an intrinsic stability S from 1 to 2.5 and/or a peptisation level Sa from 0 to 0.6; when reference is made to a hydrocarbonated component, this includes a single hydrocarbonated component, as well as one or several hydrocarbonated components; when reference is made to the description or the invention, this includes equally a single aspect or several aspects, such as described in the present text. The different aspects described in the present text are included under the term «invention».

Thus, in particular, when reference is made to a hydroxide XOH, this means at least one hydroxide XOH (NaOH or KOH) and therefore a single hydroxide NaOH or KOH, as well as any mixture of hydroxides NaOH and KOH; when reference is made to a hydrocarbonated compound, a bitumen base or a soft-grade bitumen, this includes a single one of these elements or combination of a mixture or one or several of these elements. Nevertheless, preferentially, these terms designate a single one of these elements.

In the present text, «hydroxide» and «hydroxide XOH» are used interchangeably and designate NaOH, KOH and mixtures thereof.

Similarly, «bitumen base having an intrinsic stability S from 1 to 2.5 and/or a peptisation level Sa of 0 to 0.6» and «bitumen base» are used interchangeably, unless the context clearly shows that this concerns another bitumen base.

In the present text, unless otherwise specified, when a standard is referred to, the latter refers to the most recent version of this standard available on 1 Dec. 2019.

### Bitumen Base

The bituminous compositions according to the invention comprise a bitumen base having an intrinsic stability S from 1 to 2.5 and/or a peptisation level Sa from 0 to 0.6, said values S and Sa being measured according to standard ASTM D 7157-12. In particular, such a bitumen base has, at the same time, an intrinsic stability S from 1 to 2.5 and/or a peptisation level Sa from 0 to 0.6.

In the present text, the values S and Sa are measured according to standard ASTM 7157-12.

The method for measurement of the intrinsic stability according to standard ASTM 7157-12 quantifies intrinsic stability S of the petroleum distillation residues containing asphaltenes. This stability S depends on the aromatic nature of asphaltenes, indexed by the value Sa and the aromatic nature of the medium, This method thus makes it possible to characterise the petroleum cuts resulting from the petroleum distillation process. This method, in particular, makes it possible to distinguish between the petroleum distillation residues according to their intrinsic stability S and the aromatic nature of the asphaltenes quantified by the peptisation level of the asphaltenes Sa.

The minimum value of S is 1. This value 1 indicates strong instability, with a strong tendency of asphaltenes to precipitate. The higher the S value, the more stable the bitumen base with low tendency of asphaltenes to precipitate.

The value Sa is linked to the length and number of aromatic chains in the asphaltenes. The higher the Sa value, the more the asphaltenes in the bitumen base are peptisable in a colloidal system.

Within the scope of the invention, the bitumen base used in the compositions of the invention is, preferably, a mixture of products resulting from visbreaking of the residues of distillation under reduced pressure said residues of distillation under reduced pressure originating from the under reduced pressure distillation of atmospheric residues, themselves originating from direct atmospheric distillation of petroleum. For reasons of simplicity, the residues of distillation under reduced pressure (or vacuum) can be called visbroken, or even visbroken residues.

The distillation under atmospheric pressure and distillation under reduced pressure processes, used in petroleum refining are known to the person skilled in the art, as reported in the field of the invention presentation. All distillation processes under atmospheric pressure, leading to a residue of distillation under atmospheric pressure and all distillation processes under reduced pressure, and leading to a residue of distillation under reduced pressure (or under vacuum) can be used.

The visbreaking processes consist in thermal cracking of heavy fractions (in this case residues of distillation under reduced pressure) at a temperature in the range from 420° C. to 500° C., preferably in the range from 450° C. to 460° C., without provision of hydrogen. Visbreaking is generally carried out under pressure in the range from 5000 to 20000 hPa. These products resulting from visbreaking of vacuum distillation residues comprise asphaltenes that are unstable in the colloidal state, relative to traditional bitumen resulting from direct distillation of petroleum (atmospheric and/or under vacuum). The instability of asphaltenes generally results in a degradation of cold performance. This degradation of cold performance is corrected in the context of the invention, by adding hydroxide.

Preferably, the bitumen base used within the scope of the invention presents needle penetration at 25° C. of 1 to 250 1/10 mm, preferably from 5 to 100 1/10 mm, preferentially from 5 to 40 1/10 mm, even more advantageously from 10 to 30 1/10 mm, it being understood that penetration is measured according to standard EN 1426.

Preferably, the bitumen base used within the scope of the invention has a ball and ring softening temperature (BRT) comprised between 35° C. and 100° C., preferably from 40° C. to 85° C., preferentially from 50° C. to 80° C. and even more advantageously from 55° C. to 70° C., BRT being measured according to standard EN 1427.

The bitumen base used within the scope of the invention if it is no modified in accordance with the invention by incorporation of hydroxide does not comply with road construction requirements. In particular, after RTFOT ageing (at a temperature of 163° C., for 75 minutes and under air flow of 4 litres/min), according to standard EN 12607-1, the variation in the ball and ring softening temperature of said composition, determined according to standard EN 1427, is higher than 8° C., namely from 8 to 20° C. Similarly, the maintenance of needle penetration at 25° C. of said bitumen base, determined according to standard EN 1426, is less than or equal to 60%, namely from 10 to 60%. Moreover, after RTFOT ageing (at a temperature of 163° C., for 75 minutes and under air flow of 4 litres/min)+PAV (at a temperature of 100° C., for 20 hours and at a pressure of 2100 kPa), according to standards EN 12607-1 and EN 14769, the variation in the ball and ring softening temperature of the bitumen base, determined according to standard EN 1427, is greater than 16° C., namely from 16 to 30° C.

As a result of the invention, it is possible to obtain compositions which combine such a bitumen base and a hydroxide, in such a way as to meet road construction requirements. Thus, after RTFOT ageing (at a temperature of 163° C., for 75 minutes and under air flow of 4 litres/min), according to standard EN 12607-1, the variation in the ball and ring softening temperature of said composition, determined according to standard EN 1427, is lower than 8° C. and/or maintenance of needle penetration at 25° C. of said composition, determined according to standard EN 1426, is greater than 60%. Moreover, after RTFOT ageing (at a temperature of 163° C., for 75 minutes and under air flow of 4 litres/min)+PAV (at a temperature of 100° C., for 20 hours and at a pressure of 2100 kPa), according to standards EN 12607-1 and EN 14769, the variation in the ball and ring softening temperature of said composition, determined according to standard EN 1427, is less than 16° C. and/or maintenance of needle penetration at 25° C. of said composition, determined according to standard EN 1426, is greater than 50%.

### Hydroxide

The invention relates to compositions of which at least 50% by weight, and preferably at least 80% by weight, and preferably at least 90% by weight, of the total weight of the composition, is made up of a bitumen base having an intrinsic stability S from 1 to 2.5 and/or a peptisation level Sa from 0 to 0.6, modified by the incorporation of a hydroxide XOH in which X=Na or K, with preferably X=Na.

Within the scope of the invention, when it relates to «hydroxide XOH» or «hydroxide», this means a hydroxide XOH in which X=Na or K, with preferably X=Na (which corresponds to soda).

Within the scope of the invention, such a hydroxide is used in a composition of which at least 50% by weight, and preferably at least 80% by weight, and preferably at least 90% by weight, of the total weight of the composition, is made up of a bitumen base having an intrinsic stability S from 1 to 2.5 and/or a peptisation level Sa from 0 to 0.6, to improve the composition's resistance properties to ageing and/or to improve its cold performance, and in particular its resistance to cracking at low temperatures.

In particular, a hydroxide XOH with X=Na or K can be introduced into such a bitumen base representing at least 50% by weight, preferably at least 80% by weight, and preferentially at least 90% by weight, of the total weight of a bituminous composition, to improve the properties of said composition, more precisely to improve resistance to ageing under RTFOT (at a temperature of 163° C., for 75 minutes and under air flow of 4 litres/min) according to the standard EN 1426 and/or the resistance to ageing under RTFOT (at a temperature of 163° C., for 75 minutes and under air flow of 4 litres/min)+PAV (at a temperature of 100° C., for 20 hours and at a pressure of 2100 kPa), according to standards EN 12607-1 and EN 14769.

Advantageously, the hydroxide XOH with X=Na or K can be introduced into such a bituminous composition which comprises a bitumen base having an intrinsic stability S from 1 to 2.5 and/or a peptisation level Sa from 0 to 0.6 (measured according to standard ASTM D 7157-12), said bitumen base representing at least 50% by weight, preferably at least 80% by weight, and preferentially at least 90% by weight, of the total weight of the bituminous composition, in an amount representing from 0.001 to 1% by weight, preferably from 0.002 to 0.5% by weight, and preferentially from 0.01 to 0.5% by weight of the total weight of the bituminous composition, so as to lead:
after RTFOT ageing (at a temperature of 163° C., for 75 minutes and under air flow of 4 litres/min), according to standard EN 12607-1, to a variation in the ball and ring softening temperature, determined according to standard EN 1427, of less than 8° C. and/or maintenance of needle penetration at 25° C., determined according to standard EN 1426, greater than 60%; and/or
after RTFOT ageing (at a temperature of 163° C., for 75 minutes and under air flow of 4 litres/min)+PAV (at a temperature of 100° C., for 20 hours and at a pressure of 2100 kPa), according to standards EN 12607-1 and EN 14769, to a variation in the ball and ring softening temperature, determined according to standard EN 1427, of less than 16° C. and/or maintenance of needle penetration at 25° C., determined according to standard EN 1426, greater than 50%.

The hydroxide XOH with X=Na or K, can also be introduced into a bituminous composition which comprises a bitumen base having an intrinsic stability S from 1 to 2.5 and/or a peptisation level Sa from 0 to 0.6, said values S and Sa being measured according to standard ASTM D 7157-1, said bitumen base representing at least 50% by weight, preferably at least 80% by weight, and preferentially at least 90% by weight, of the total weight of the bituminous composition, in an amount representing from 0.001 to 1% by weight, preferably from 0.002 to 0.5% by weight, and preferentially from 0.01 to 0.5% by weight, of the total weight of the bituminous composition, to improve resistance to low temperatures evaluated according to standard DIN EN 14771, the % by weight given for the bitumen base and hydroxide being calculated relative to the total weight of the bituminous composition including the hydroxide. Advantageously, the improvement in resistance to low temperatures ins in the order of 10 to 50%, preferably 15 to 50%, and preferentially 20 to 50%.

Advantageously, the variation after RTFOT ageing of T(S=300 MPa) of a bitumen base having an intrinsic stability S from 1 to 2.5 and/or a peptisation level Sa from 0 to 0.6, is at least 40%, preferably at least 50% higher than the variation after RTFOT of the composition according to the invention.

Advantageously, the variation after RTFOT of T(m=0.3) of a bitumen base having an intrinsic stability S from 1 to 2.5 and/or a peptisation level Sa from 0 to 0.6, is at least 40%, preferably at least 50% higher than the variation after RTFOT of the composition according to the invention.

RTFOT ageing is carried out as described within the scope of the invention.

The hydroxide can thus be used to modify any composition of which at least 50% by weight, and preferably at least 80% by weight, and preferably at least 90% by weight, of the total weight of the composition, is made up of a bitumen base having an intrinsic stability S from 1 to 2.5 and/or a peptisation level Sa from 0 to 0.6, whether this composition comprises solely such a bitumen base or whether it includes an additive envisaged within the scope of the invention.

In particular, the hydroxide XOH, can be used in the form of a hydrocarbonated composition IC comprising a hydrocarbonated component CH and the hydroxide XOH. A hydrocarbonated composition IC will, preferably, consist exclusively of a mixture of the hydroxide XOH and a hydrocarbonated component CH. Advantageously, the hydroxide XOH is found in such a hydrocarbonated composition IC in the form of particles with at least 80% by number of said particles having a maximum size in the range from 10 to 100 μm, preferably in the range from 20 to 60 μm. Such a particle size allows better control and optimum adjustment of the properties of the bituminous composition obtained. The maximum size of a particle which, in general, has an irregular form, corresponds to its greatest dimension, in particular, measured with microscope, and preferably a visible light microscope. When a hydrocarbonated composition IC is used, the hydroxide XOH represents, advantageously from 15 to 50% by weight, in particular from 15 to 25% by weight, of the weight of said hydrocarbonated composition IC. Such a hydrocarbonated composition IC is, therefore, incorporated into the composition comprising the bituminous base selected.

### Hydrocarbonated Component

In the bituminous compositions according to the invention, the hydroxide XOH, can be added, through the intermediary of a hydrocarbonated composition IC comprising in addition to the hydroxide XOH a hydrocarbonated component CH. In such cases, the hydrocarbonated component CH is therefore also found in the bituminous composition according to the invention. In particular, a bituminous composition according to the invention comprises a hydrocarbonated component CH, in particular chosen from among hydrocarbonated oils, soft-grade bitumen, fluxed bitumen, fluidified bitumen, and mixtures thereof, said hydrocarbonated component CH preferably representing at the most 10% by weight, preferentially 0.1 to 10% by weight, in a most preferred way 0.5 to 8% by weight, and in an even more preferred way 1 to 5% by weight, of the total weight of the bituminous composition according to the invention.

In the present invention, by «hydrocarbonated component» is meant a hydrocarbon, or a component comprising a hydrocarbon, or a compound comprised essentially of a hydrocarbon or a mixture of hydrocarbons. A hydrocarbon is made up entirely of hydrogen and carbon atoms, said compound being saturated or unsaturated, cyclic or acyclic. The alkanes, cycloalkanes, alkenes, alkynes and aromatic hydrocarbons, particularly the arenes, are different examples of hydrocarbons. As preferred examples of a hydrocarbonated component CH that can be used within the scope of the invention, one can cite hydrocarbonated oils and bitumen. The hydrocarbonated component does not correspond, preferably, to a bitumen base having an intrinsic stability S from 1 to 2.5 and/or a peptisation level Sa from 0 to 0.6.

Advantageously, the hydrocarbonated component CH is bitumen, preferably a soft-grade bitumen such as defined in standard EN 12591 (version 2009), for example under the reference V1500, V3000, V6000 or V12000; or a fluxed or fluidified bitumen such as that defined in standard EN 15322 (version 2013), for example reference Fm 3-225 X 0, Fm 4-75 X 0, Fm 4-150 X 0, Fm 4-300 X 0, Fm 8 x 0, Fv 3-30 X 0, Fv 3-60 X 0, Fv 3-120 X 0, Fv 5-60 X 0, Fv 5-180 X 0, Fv 8 x 0 or Fv 9 x 0.

Other adapted examples of a hydrocarbonated component CH that can be used within the scope of the invention, other than bitumen, are hydrocarbonated oils. Such oils can be mineral oils, synthetic oils, fluxed oils, alkanes, such as TOTAL cylinder oil 1000 N. When an oil is used, it is preferably neutral or basic.

The hydrocarbonated component CH has, preferably, a kinematic viscosity at 60° C. in the range from 50 to 20,000 mm²/s, preferably in the range from 50 to 150 mm²/s. Such a kinematic viscosity may be measured according to standard EN 12595. With such viscosity, the hydrocarbonated composition IC comprising the hydroxide XOH and the hydrocarbonated component CH may be prepared with conventional stirrers, in particular blade stirrers.

According to another advantageous feature, the hydrocarbonated component CH has a transmittance of light at a wavelength of 900 nm of at least 0.03%. This transmittance can be measured using a photometer such as the Hach Lange DR 3900, photometer in particular with a 1 cm optical glass cuvette. With such transmittance, it is possible to verify, in particular by microscopy under visible light, that the hydroxide XOH is found in the form of particles in the hydrocarbonated composition IC, and to verify the size of said particles. In particular, it will be verified that the hydroxide XOH is found in the composition IC in the form of particles with a mean maximum size less than or equal to 100 μm, preferably less than or equal to 60 μm and in particular that they have a mean maximum size in the range from 10 to 100 μm, preferably in the range from 20 to 60 μm.

### Additive(s)

The bituminous compositions according to the invention may comprise exclusively a bitumen base having an intrinsic stability S from 1 to 2.5 and/or a peptisation level Sa from 0 to 0.6 and a hydroxide XOH such as described within the scope of the invention, may be exclusively comprised of a bitumen base which has an intrinsic stability S from 1 to 2.5 and/or a peptisation level Sa from 0 to 0.6, a hydroxide XOH and a hydrocarbonated component CH such as described within the scope of the invention, or may also include one or several additives.

In particular, if the hydroxide XOH is introduced via the intermediary of a hydrocarbonated composition IC comprising a hydrocarbonated component CH, the bituminous composition according to the invention will include such a hydrocarbonated component CH.

Thus, the invention relates to bituminous compositions which comprise, in addition to the bitumen base which has an intrinsic stability S from 1 to 2.5 and/or a peptisation level Sa from 0 to 0.6 and the hydroxide, a hydrocarbonated component CH, preferably chosen from among hydrocarbonated oils, soft-grade bitumen, fluxed bitumen, fluidified bitumen and mixtures thereof, particularly those described in the «Hydrocarbonated component» section.

In general, said hydrocarbonated component CH represents, preferably, at most 10% by weight, preferentially 0.1 to 10% by weight, in a more preferred manner 0.5 to 8% by weight, and in an even more preferred manner 1 to 5% by weight, of the total weight of the bituminous composition according to the invention.

Moreover, the bituminous compositions according to the invention can include one or several additives, whose incorporation has already been described for bitumen compositions.

In particular, the bituminous compositions according to the invention can also include an adhesion promoter, namely chosen from among amines, diamines, polyamines, alkyl amido amines, amidopolyamines, imidazolines, and mixtures thereof. Such adhesion promoters are described, in particular, in application WO 2018/206489 which can be referred to for more details.

In particular, such an adhesion promoter is chosen from among:

i) Amines of formula (I):

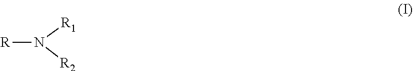

wherein:
R is a saturated or unsaturated, substituted or unsubstituted, optionally branched or cyclic, hydrocarbon radical with 8 to 24 carbon atoms, for example derived from tallow fatty acids, or tall oil fatty acids; and
R₁ and R₂ can be the same or different and are selected from hydrogen atom or hydrocarbon radical with 1 to 24 carbon atoms; R₁ and R₂ are preferably selected from a hydrogen atom or methyl group;
   ii) Diamines and polyamines of formula (II):

R—(NH-L)n-NH₂ (II)

wherein:
R has the same meaning as in (I) above,
L represents a linear or branched hydrocarbon radical with 1 to 6 carbon atoms, for instance L is —(CH₂)ₘ— with m=1, 2 or 3 and,
n is an integer greater than or equal to 1, in particular n is an integer equal to 1, 2, 3, 4, 5 or 6;
   iii) Alkyl amido amines of formula (III):

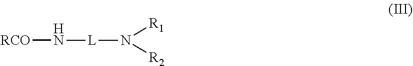

wherein R, R₁, R₂ and L have the same meaning as in (I) and (II), above;
iii) Alkyl amido amines of formula (III):

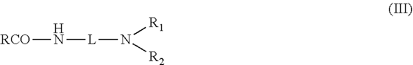

wherein R, R₁, R₂ and L have the same meaning as in (I) and (II), above;
iv) Amidopolyamines of formula (IV) and imidazolines:

RCO—(NH-L)ₚ-NH₂ (IV)

wherein R and L have the same meaning as in (I) and (II) above, and p is an integer greater than or equal to 1, in particular p is an integer from 1 to 10.

Advantageously, the amine additive is selected from amines, diamines, polyamines, alkyl amido amines and amidopolyamines including a fatty chain. According to a specific embodiment, the amine additive is an amidopolyamine including a fatty chain of formula:

RCO—[NH-L]p-NH₂ (IV)

where:
p is an integer greater than or equal to 1, in particular p is an integer from 1 to 10,
L is a linear or branched hydrocarbon chain with 1 to 6 carbon atoms, for example
L is —(CH₂)ₘ— with m=1, 2 or 3,
R is a saturated or unsaturated, substituted or unsubstituted, optionally branched hydrocarbon radical with 8 to 24 carbon atoms.

In a preferred manner, the adhesion promoter used in the bituminous compositions according to the invention is a mixture of amidopolyamines of formula (IV) in which p is an integer in the range from 1 to 10, L is —(CH₂)₂—, and R corresponds to the hydrocarbonated chains of tall oil fatty acids.

In general, when it is present, said adhesion promoter represents, preferably, 0.01 to 2% by weight, preferentially 0.05% to 1% by weight, and in an even more preferred way 0.1 to 0.3% by weight, of the total weight of the bituminous composition according to the invention.

It is also possible to include, as is done, in certain bitumen compositions, one or more polymers.

The bituminous compositions according to the invention may include an agent (called a temperature reducing agent) allowing a reduction in the temperature at which bituminous compositions according to the invention can be used in a satisfactory manner, as a binder. As an example of a temperature reducer, mention can be made as an example, of derivatives of tall oil, taken alone or in combination with a monoester of a mixture of fatty acids, such as those described in document WO 2010/134024. Mention can also be made, as suitable additives according to the invention, of the additives described in document WO 2012/049579 and in document WO 2014/095995. Preferably, agents in particular those sold by Arkema, are used, under the reference Cecabase RT bio 10, in particular.

In general, when it is present, said temperature reducer represents, preferably, 0.01 to 3% by weight, and preferentially 0.05 to 0.3% by weight, of the total weight of the composition according to the invention.

### Method for the Preparation of Bituminous Compositions According to the Invention

The bituminous compositions according to the invention can be prepared by any suitable method, known to the person skilled in the art. As a general rule, these methods include mixing the components and heating the mixture.

The hydroxide can be introduced directly into an initial bituminous composition, directly in the form of a powder or in the form of a solution in a suitable solvent, Mention can be made of cite water and methanol as examples of suitable solvents. The hydroxide may be present in such a solution, for instance at a concentration from 10 to 50% by weight, relative to the total weight of the solution, A suitable solvent will preferably have a boiling point less than or equal to 100° C. at 1013.3 hPa. It will be chosen preferably such that it evaporates spontaneously when the hydroxide solution is incorporated into the initial bituminous composition.

Whether it is introduced directly in the form of a powder or a solution in a solvent, the amount introduced is chosen so as to finally obtain in the bituminous composition according to the invention, an amount of hydroxide which represents from 0.001 to 1% by weight, preferably 0.002 to 0.5% by weight, and preferentially from 0.01 to 0.5% by weight, of the total weight of the bituminous composition obtained.

Advantageously, the hydroxide is introduced into an initial bituminous composition, in the form of a particle powder with a maximum size less than or equal to 100 μm, preferably less than or equal to 60 μm. In a still more preferred manner, the hydroxide is introduced, in an initial bituminous composition, in the form of a particle powder with a maximum size in the range from 10 to 100 μm, preferably from 20 to 60 μm. An anhydrous powder is used preferably. The mean maximum size of particles corresponds to the arithmetic mean of the maximum sizes of a set of particles, preferably at least 20 particles, and especially 20 particles. The maximum size can be measured by microscopy. The size of particles introduced can be adjusted by different techniques, in particular by grinding and/or sieving.

According to a preferred embodiment, the hydroxide, in particular, in the form of particles, is introduced by means of a hydrocarbonated composition IC.

Such a hydrocarbonated composition IC comprises or is even constituted exclusively of the hydroxide distributed in a hydrocarbonated component CH such as that described previously.

In particular, the hydroxide represents, preferably, 15 to 50% and preferentially 15 to 25% by weight, of the total weight of the hydrocarbonated composition IC. Similarly, to what is described in the case of direct introduction of the hydroxide into the initial bituminous composition, the hydroxide can be introduced in the hydrocarbonated component CH, directly in the form of a powder or in solution in a suitable solvent. However, advantageously, the hydroxide is introduced, in the hydrocarbonated composition IC, in the form of a particle powder with a maximum size less than or equal to 100 μm, preferably less than or equal to 60 μm. Even preferentially, the hydroxide can be introduced in the hydrocarbonated component CH, directly in the form of a powder or in solution in a suitable solvent. However, advantageously, the hydroxide is introduced, in the hydrocarbonated composition IC, in the form of a particle powder with a mean maximum size in the range from 10 to 100 μm, preferably from 20 to 60 μm. An anhydrous powder will preferably be used.

Advantageously, the hydrocarbonated component CH, of the hydrocarbonated composition IC, has a transmittance of light, at a wavelength of 900 nm, of at least 0.03%. This transmittance can be measured using a photometer such as the Hach Lange DR 3900 photometer in particular with a 1 cm optical glass cuvette. With such transmittance, it is possible to verify by microscopy, in particular by microscopy under visible light, that the hydroxide does actually form particles in the hydrocarbonated composition IC. In general, when the hydroxide is incorporated into the hydrocarbonated composition IC, in the form of particles of a given size, this size is preserved or at least substantially preserved in the hydrocarbonated composition IC. Most often, in the powder as well as in the hydrocarbonated composition IC, the hydroxide particles are not spherical and have irregular shapes. When it concerns the size of particles within the scope of the invention, what is meant is the maximum size which corresponds to the largest dimension which can be measured, especially with a microscope. This size can be measured directly from the composition IC if the transmittance of the hydrocarbonated component CH is sufficient.

In particular in the hydrocarbonated composition IC, the hydroxide forms particles of which at least 80% by number have a maximum size in the range from 10 to 100 μm, preferably, in the range from 20 to 60 μm and/or having a maximum size less than or equal to 100 μm, preferably less than or equal to 60 μm. In an even more preferred manner, the hydroxide XOH is found in the composition IC in the form of particles with a mean maximum size in in the range from 10 to 100 μm, preferably in in the range from 20 to 60 μm. On the other hand, the size of the hydroxide particles cannot be verified in the bituminous composition according to the invention.

Moreover, the use of a hydrocarbonated composition IC comprising the hydroxide makes it possible to protect the hydroxide against humidity and to improve its storage, prior to its introduction into the initial bituminous composition.

Advantageously, such a hydrocarbonated composition IC comprises a hydrocarbonated component with a kinematic viscosity at 60° C. measured according to EN 12595 in the range from 50 to 20,000 mm²/s, preferably in the range from 50 to 150 mm²/s. With such viscosities, the preparation of such a composition and the introduction of the hydroxide requires a conventional mixing device, such as blade stirrers.

In particular, the preparation of a hydrocarbonated composition IC may be carried out by mixing a hydrocarbonated component CH and the hydroxide at a temperature in the range from 30 to 220° C., preferably in the range from 40 to 190° C. and/or with stirring in the range from 300 to 800 rpm, preferably in in the range from 500 to 650 rpm and/or for a period of 10 to 120 minutes, preferably from 10 to 20 minutes. The mixing and temperature parameters will be adjusted by the person skilled in the art as a function of the hydrocarbonated component CH used.

During preparation of such a hydrocarbonated composition IC, the hydrocarbonated component CH may be heated at a temperature at which it is found in the liquid state, in such a way as to promote the incorporation and distribution of the hydroxide. For example, a temperature that is just sufficient to obtain melting of the hydrocarbonated component CH can be used, in particular when the hydroxide is introduced in the form of a powder. When the hydroxide is introduced in the form of a solution in a solvent, preferably, the hydrocarbonated component CH will be subjected to suitable heating to achieve spontaneous evaporation of the solvent, simultaneously to incorporation of the hydroxide solution.

When the hydroxide is introduced through the intermediary of a hydrocarbonated composition IC, the amount present in this composition determines the amount of hydrocarbonated composition IC introduced. Indeed, this hydrocarbonated composition IC is introduced in an amount as in the initial bituminous composition, in a manner to finally obtain in the bituminous composition according to the invention, an amount of hydroxide which represents from 0.001 to 1% by weight, preferably from 0.002 to 0.5% by weight, and preferentially, from 0.01 to 0.5% by weight, of the total weight of the bituminous composition obtained.

In general, the weight percentage of the hydroxide in the hydrocarbonated composition IC is at least 30 times equal to the weight percentage of the hydroxide in the final bituminous composition and, preferably, at the most 100 times equal to the weight percentage of hydroxide in the final bituminous composition according to the invention.

The method for preparation of the bituminous compositions according to the invention can include the preparation of a hydrocarbonated composition IC, when such a composition is used to introduce hydroxide in the initial bituminous composition. It is also possible that the method for preparation of bituminous compositions according to the invention comprises a storage step of the hydrocarbonated composition IC for at least one hour and for example for a period of 1 to 30 days, particularly at a temperature in the range from 10 to 40° C. and, preferably, at a temperature in the range from 20 to 30° C., and, particularly in ambient air. The hydrocarbonated composition IC is fairly stable under such conditions, so that even the same hydrocarbonated composition IC with specific characteristics may be used for the preparation of several bituminous compositions. Moreover, the hydrocarbonated composition IC can be stored and transported without particular precautions, contrary to the hydroxide XOH.

According to the embodiments, which can be combined with the preceding, before the addition of the hydroxide to the initial bituminous composition, the method according to the invention can include a verification step, for example by microscopy, and advantageously by visible light microscopy, that the hydroxide forms particles in the hydrocarbonated composition IC with at least 80% by number of said particles having a mean maximum size in the range from 10 to 100 μm, and preferentially in the range from 20 to 60 μm and/or said particles having a maximum size less than or equal to 100 μm, preferably less than or equal to 60 μm. In an even more preferred manner, the method according to the invention can include a verification step, for example by microscopy, and advantageously by visible light microscopy, that the hydroxide XOH is found in the hydrocarbonated composition IC in the form of particles having a maximum size in the range from 10 to 100 μm, preferably in the range from 20 to 60 μm.

When an intermediary composition IC is used, before its introduction in the initial bituminous composition, the hydrocarbonated composition IC will be, preferably, heated at a temperature in the range from 30 to 50° C., preferably in the range from 40 to 50° C., advantageously with stirring and, in particular, stirring at 300 to 1000 rpm, preferably stirring from 400 to 800 rpm and/or for a period of 10 to 120 minutes, preferably from 10 to 20 minutes. A low temperature, preferably 40 to 50° C., is also advantageous to promote control of the size of the particles of hydroxide XOH.

Such a temperature is, in particular, used when the component CH has a kinematic viscosity at 60° C. in the range from 20 to 20,000 mm²/s, preferably in the range from 50 to 150 mm²/s. Here again, the mixing and temperature are adjusted by the person skilled in the art as a function of the hydrocarbonated component CH selected.

Conventionally, the hydroxide, whether introduced directly in the form of a powder, solution or hydrocarbonated composition IC, is done so, in the initial bituminous composition, with mixing and heating. In general, the initial bituminous composition is heated with stirring, prior to incorporation of the hydroxide. The mixing and heating parameters will be adjusted by the person skilled in the art as a function of the properties of the initial bituminous composition used.

The incorporation of hydroxide particles, whether this is in the form of a powder, a solution or a hydrocarbonated composition IC, may be carried out by mixing at a temperature in the range from 150 to 220° C., preferably at a temperature in the range from 160 to 190° C. and/or with stirring in the range from 100 to 500 rpm, preferably in the range from 200 to 400 rpm and/or for a period of 10 to 120 minutes. The mixing and heating can be maintained for a period of time at the end of incorporation, in particular at a temperature ranging from 160 to 190° C. and/or with stirring in the range from 100 to 500 rpm, and/or for a period of 10 to 240 minutes.

Whatever the method used, the final bituminous composition can correspond to the composition obtained directly at the end of step b. When the bituminous composition includes one or several additives, these additive(s) may be incorporated in the bituminous composition before introduction of the hydroxide or introduced after the hydroxide. When the composition includes several other additives, it is, also, possible that one or other additives might already be present and that one or several additive(s) are introduced later. According to a preferred embodiment, the method according to the invention includes after step b, an additional step corresponding to the addition of an additive leading to a final bituminous composition.

In particular, when the final bituminous composition includes an adhesion promoter such as that described within the scope of the invention, such an adhesion promoter is, preferably, introduced in step c, subsequently to step b after introduction of the hydroxide.

In the method according to the invention, initial bituminous composition refers to the composition comprising a substantial amount of a bitumen base having an intrinsic stability S from 1 to 2.5 and/or a peptisation level Sa from 0 to 0.6, in which the hydroxide is introduced. The latter may consist exclusively of a bitumen base having an intrinsic stability S from 1 to 2.5 and/or a peptisation level Sa from 0 to 0.6 of a mixture of such a bitumen base with one or several additives(s) and/or a bitumen base. The components of the initial bituminous compositions will be present in amounts adapted to obtain the desired amounts in the bituminous composition according to the invention. Although this is not preferred, it is not excluded that the initial bituminous composition includes another bitumen base, and in particular a hard-grade bitumen, particularly of grade 10/20 or 15/25 specified by standard 13924-1 or 20/30, 30/45 or 35/50 specified by standard EN 12591, but in limited amounts, such that in the end, the bitumen base having an intrinsic stability S from 1 to 2.5 and/or a peptisation level Sa from 0 to 0.6, represents at least 50% by weight, and preferably at least 80% by weight, and preferentially at least 90% by weight, of the total weight of the bituminous composition obtained. In particular, the absence of hard-grade bitumen in the initial bituminous composition makes it possible to make up just one mixture in the drum, as incorporation of the hydroxide can be carried out in-line directly.

### Compositions According to the Invention—Preferred Embodiments

The invention relates to bituminous compositions comprising a bitumen base having an intrinsic stability S from 1 to 2.5 and/or a peptisation level Sa from 0 to 0.6, represents at least 50% by weight, and preferably at least 80% by weight, and preferentially at least 90% by weight, of the total weight of the bituminous composition and a hydroxide XOH such as described within the scope of the invention. Said compositions may also include one or several additives, in particular those described previously. Moreover, although these embodiments are not preferred, it is possible that the compositions according to the invention also comprises a hard-grade bitumen, in particular grade 10/20 or 15/25 specified by standard 13924-1 or 20/30 or 30/45 or 35/50 specified by standard EN 12591. Preferably, when it is present, such a hard-grade bitumen represents at the most 20% by weight of the total weight of the bituminous composition according to the invention.

In the bituminous compositions according to the invention, the various components are distributed in the bitumen base. Such distribution is obtained due to mixing applied during preparation of the compositions according to the invention.

Some of the particularly preferred compositions within the scope of the invention are given hereafter. The % given are % weights, relative to the total weight of the composition. Advantageously, in the description hereafter, the first ranges cited are used together for the different components listed, or the second ranges cited for the different components listed, or the third ranges cited for the different components listed.

In particular, the invention relates to the compositions comprising the following components:
from 60 to 99.999%, preferably, from 80 to 99.998%, and preferentially from 90 to 99.99% of a bitumen base having an intrinsic stability S from 1 to 2.5 and/or a peptisation level Sa from 0 to 0.6,
from 0.001 to 1%, preferably, from 0.002 to 0.5%, and preferentially from 0.01 to 0.5% of hydroxide XOH in which X=Na and K; and advantageously from 0.001 to 1%, preferably, from 0.002 to 0.5%, and preferentially from 0.01 to 0.5% of soda.

According to certain embodiments, the invention relates to the compositions comprising the following components:
from 60 to 99.899%, preferably, from 80 to 99.498%, and preferentially from 90 to 98.99% of a bitumen base having an intrinsic stability S from 1 to 2.5 and/or a peptisation level Sa from 0 to 0.6, and
from 0.001 to 1%, preferably, from 0.002 to 0.5%, and preferentially from 0.01 to 0.5% of hydroxide XOH in which X=Na or K; and advantageously from 0.001 to 1%, preferably, from 0.002 to 0.5%, and preferentially from 0.01 to 0.5% of soda,
from 0.1 to 10%, preferably, from 0.5 to 8%, and preferentially from 1 to 5%, of a hydrocarbonated component CH, chosen from among hydrocarbonated oils, soft-grade bitumen, fluxed bitumen, fluidified bitumen and mixtures thereof.

According to certain embodiments, the invention relates to the compositions constituted solely of the following components:
from 89 to 99.899%, preferably, from 91.5 to 99.498%, and preferentially from 94.5 to 98.99% a bitumen base having an intrinsic stability S from 1 to 2.5 and/or a peptisation level Sa from 0 to 0.6,
from 0.001 to 1%, preferably, from 0.002 to 0.5%, and preferentially from 0.01 to 0.5% of hydroxide XOH in which X=Na or K; and advantageously from 0.001 to 1%, preferably, from 0.002 to 0.5%, and preferentially from 0.01 to 0.5% of soda, and
from 0.1 to 10%, preferably, from 0.5 to 8%, and preferentially from 1 to 5% of a hydrocarbonated component CH, chosen from among hydrocarbonated oils, soft-grade bitumen, fluxed bitumen, fluidified bitumen and their mixtures thereof.

According to certain embodiments, the invention relates to the compositions comprising the following components:
from 60 to 99.889%, preferably 80 to 99.448%, and preferentially from 90.00 to 98.89 of a bitumen base having an intrinsic stability S from 1 to 2.5 and/or a peptisation level Sa from 0 to 0.6,
from 0.001 to 1%, preferably from 0.002 to 0.5%, and preferentially from 0.01 to 0.5% of hydroxide XOH in which X=Na or K; and advantageously from 0.001 to 1%, preferably, from 0.002 to 0.5%, and preferentially from 0.01 to 0.5% of soda,
from 0.1 to 10%, preferably, de 0.5 to 8%, and preferentially from 1 to 5% of a hydrocarbonated component CH, chosen from among hydrocarbonated oils, soft-grade bitumen, fluxed bitumen, fluidified bitumen and mixtures thereof,
from 0.01 to 2%, preferably from 0.05 to 1%, and preferentially from 0.1 to 0.3% of adhesion promoter, preferably chosen from among amines, diamines, polyamines, alkyl amido amines, amidopolyamines, imidazolines, and mixtures thereof.

According to certain embodiments, the invention relates to compositions constituted exclusively of the following components:
from 87 to 99.889%, preferably from 90.5 to 99.448%, and preferentially from 94.2 to 98.89% of a bitumen base having an intrinsic stability S from 1 to 2.5 and/or a peptisation level Sa from 0 to 0.6,
from 0.001 to 1%, preferably from 0.002 to 0.5%, and preferentially from 0.01 to 0.5% of hydroxide XOH in which X=Na or K; and advantageously from 0.001 to 1%, preferably, from 0.002 to 0.5%, and preferentially from 0.01 to 0.5% of soda,
from 0.1 to 10%, preferably, from 0.5 to 8%, and preferentially from 1 to 5% of a hydrocarbonated component CH, chosen from among hydrocarbonated oils, soft-grade bitumen, fluxed bitumen, fluidified bitumen and mixtures thereof,
from 0.01 to 2%, preferably, from 0.05 to 1%, and preferentially from 0.1 to 0.3% of adhesion promoter, preferably chosen from among amines, diamines, polyamines, alkyl amido amines, amidopolyamines, imidazolines, and mixtures thereof.

Obviously, the bitumen base having an intrinsic stability S from 1 to 2.5 and/or a peptisation level Sa from 0 to 0.6 and the hydroxide, the adhesion promoter, and the hydrocarbonated component CH, when they are present, correspond, preferably, to those specifically described or preferred within the scope of the invention. In particular, in the previously described compositions, the bitumen base having an intrinsic stability S from 1 to 2.5 and/or a peptisation level Sa from 0 to 0.6 is a mixture of products resulting from visbreaking of residues of distillation under reduced pressure, said residues of distillation under reduced pressure originating from distillation under reduced pressure of atmospheric residues originating from direct atmospheric distillation of petroleum.

The compositions obtained by mixing the different components listed, in the given proportions, or even obtained by mixing only the different components listed, in the given proportions, also constitute an integral part of the invention.

### Use and Applications of Bituminous Compositions According to the Invention

Various uses of the compositions according to the invention are envisaged. In particular, the compositions according to the invention can be used as a binder to replace conventional bitumen. As a binder, a composition according to the invention can be used to prepare an association with aggregates, especially for road construction. As these are road applications, the invention concerns in particular coated aggregates as materials for the construction and the maintenance of road foundations and their surfacing, and for all road works.

By mix is meant a mixture of a binder with aggregates and possibly mineral and/or synthetic fillers. The mix comprises a composition such as described within the scope of the invention, as a binder and possibly mineral and/or synthetic fillers, preferably chosen from among fines, sand, stone chips and recycled milled products. The aggregates are mineral and/or synthetic aggregates, in particular recycled milled products, of a size greater than 2 mm, preferably between 2 mm and 20 mm.

Additionally, an object of the invention is a method for the preparation of mixes comprising hot mixing of a composition according to the invention, with aggregates, and possibly mineral and/or synthetic fillers.

A composition according to the invention, can, advantageously be used to prepare a surface coat, a hot mix, cold-poured mix or grave-emulsion. As this concerns road applications, the invention also covers asphalts as materials to make and cover pavements.

By asphalt is meant a mixture of a binder with mineral and/or synthetic fillers. An asphalt comprises a composition such as that described within the scope of the invention and mineral fillers such as fines, sand, stone chips and recycled milled products. The mineral fillers consist of fines (particles with dimensions less than 0.063 mm), sand (particles with dimensions between 0.063 mm and 2 mm) and optionally of stone chips (particles with dimensions greater than 2 mm, preferably between 2 mm and 4 mm). The asphalts show 100% compactness and are mainly used to construct and cover pavements, whereas the mixes have a compactness of less than 100% and are used to construct roads. Unlike the mixes, asphalts are not compacted with a roller when being put in place.

Thus, another objective of the invention is also a method for the preparation of an asphalt comprising the hot mixing of a composition according to the invention, with mineral and/or synthetic fillers.

Another aspect of the invention relates to the use of a composition according to the invention in various industrial applications, in particular for preparing waterproof coating, a membrane or seal layer. As regards the industrial applications of the compositions according to the invention, mention can be made of the preparation of waterproof membranes, noise-reduction membranes, insulating membranes, surface coatings, carpet tiles or seal layer.

The examples below will help illustrate the invention but without limiting it in any way.

### Reagents

The sodium hydroxide was anhydrous and its purity was in excess of 99%, it was in the form of pellets (CARL ROTH GMBH & Co. KG, Article No 9356.1).

The bitumen base was obtained by visbreaking of the residues of vacuum distillation, resulting from vacuum distillation of the residues of distillation under atmospheric pressure of petroleum from the Normandy refinery. Its intrinsic stability S was 2 and its peptisation level 0.52, said values S and Sa having been measured according to standard ASTM D 7157-12.

The adhesion promoter H1 was an amine additive: WETFIX BE from Akzo Nobel Surface Chemistry AB (CAS 68910-93-0).

The fluxed bitumen was supplied by TOTAL under the reference SOFT® BITUMEN had a kinematic viscosity at 60° C. according to standard EN 12595 of 90 mm²/s. Its transmittance, measured at 900 nm with the Hach Lange DR 3900 photometer with a 1 cm optical glass cuvette, was 0.1%.

### Evaluation of the Bituminous Compositions

In the examples hereafter, the compositions were evaluated by:
measurement of needle penetration at 25° C. (abbreviation: Pene), according to standard EN 1426, the results being expressed in 1/10 mm,
measurement of the ball and ring softening temperature (abbreviation: BRT), according to standard EN 1427, the results being expressed in ° C.,
the penetration index (without units) according to standard DIN EN 1427 Appendix B,
the resistance of the compositions to hardening and ageing was respectively tested according to the standard DIN EN 12607-1 and standard DIN EN 12607-1+EN 14769.

The European Standard DIN EN 12607-1 specifies the method for measuring the combined effects of heat and air on a thin film of a composition in constant renewal (Rolling Thin Film Oven Test or RTFOT). The RTFOT ageing was conducted at a temperature of 163° C., for 75 minutes under air flow of 4 litres/min. The European Standard DIN EN 12607-1+EN 14769 specifies the method for accelerated long-term ageing carried out in a pressure ageing vessel (RTFOT+PAV). RTFOT ageing was carried out under the conditions given previously and those for PAV at a temperature of 100° C., for 20 hours and at a pressure of 2.1 MPa.
Resistance to low temperatures (Determination of flexural rigidity modulus, Bending Beam Rheometer BBR), representative of the resistance to cracking was also evaluated according to standard DIN EN 14771. T(S=300 MPA) is the temperature for which the rigidity is 300 MPA and T(m=0.3), the temperature for which the slope is equal to 0.3.

### Examples

a) Preparation of a Hydrocarbonated Composition IC

The sodium hydroxide pellets were ground to a fine powder, using a grinder IKA® A11 (IKA-Werke GmbH & Co) at 28 000 rpm, for around 30 seconds, Thus, the sodium hydroxide (NaOH) particles were obtained. Their maximum size measured from 20 particles under the microscope was around 50 μm. At the same time, 500 g of fluxed bitumen were heated at 50° C. in a reactor with a diameter of d=16 cm and stirring at 600 rpm with hotplate stirrer (diameter D of the active mechanical part), with D/d=0.4. The temperature was controlled using a thermostat. 95.24 g of powdered sodium hydroxide was put in suspension in fluxed bitumen and stirred; stirring was continued for 30 minutes. In the composition IC obtained, % by weight of NaOH was 16%, on the basis of the total weight of the composition IC obtained. The composition IC obtained was observed by microscopy under visible light, which showed that the soda was in the form of particles over 80% of which had a maximum size less than or equal to 50 μm.

b) Preparation of the Modified Bituminous Composition

The composition IC prepared previously was heated to 50° C. maximum (as the viscosity of fluxed bitumen decreases at higher temperatures, this leads to a higher decantation rate for NaOH) under stirring in a reactor with a stirrer as described in section a) (D/d=0.4) at 600 rpm for homogenising.

In parallel, 2500 g of bitumen base were heated at 180° C. in a reactor and stirred using a stirrer such as described in section a) (D/d=0.4) close to 400 rpm to homogenise the bitumen base. The prepared composition IC was added directly to the bitumen base (3.23 g of composition IC per 100 g of bitumen base=3.13% by weight in the final bituminous composition). At the end of the addition of composition IC, stirring was continued for 30 minutes.

The mixture continued to be stirred for 3 hours at 600 rpm. The temperature of the mixture was set not to exceed 170° C. Samples were removed from the reactor regularly to measure the BRT and Pene. Mixing was stopped when the two stabilised. Next, the mixture was cooled down to 160° C. and 5.04 g of the adhesion promoter H1 were added. Mixing was maintained for 20 minutes. In the final bitumen base composition, the % by weight of NaOH was 0.500%, the adherence promoter H1 was 0.194% by weight and fluxed bitumen 2.623% by weight, on the basis of the total weight of the bitumen base composition.

Table 1 below gives BRT and Pene, before and after RTFOT and RTFOT+PAV, for the bitumen base alone and for the bituminous composition according to the invention.

TABLE 1

| | | | Bituminous | Bituminous | Bituminous |
|---|---|---|---|---|---|
| | | | composition | composition | composition |
| Parameter | Standard | Unit | Reference | Modified H1 | Invention |
| TBA | DIN EN 1427 | ° C. | 66.2 | 66.0 | 69.2 |
| Pene | DIN EN 1426 | mm/10 | 9 | 10 | 12 |
| Penetration | DIN EN 1427 | — | −1.1 | | −0.2 |
| index | Appendix B | | | | |
| Resistance to | DIN EN | — | | | |
| ageing RTFOT | 12607-1 | | | | |
| BRT | DIN EN 1427 | ° C. | 75.8 | 75.6 | 75.6 |
| BRT change | DIN EN 1427 | ° C. | 9.6 | 9.6 | 6.4 |
| Pene | DIN EN 1426 | mm/10 | 5 | 6 | 8 |
| Maintenance | DIN EN 1426 | % | 56 | 60 | 67 |
| of Pene | | | | | |
| Resistance to | DIN EN | — | | | |
| ageing RTFOT | 12607-1 + 14769 | | | | |
| and PAV | | | | | |
| BRT | DIN EN 1427 | ° C. | 86.0 | 86 | 84.5 |
| BRT Change | DIN EN 1427 | ° C. | 19.8 | 20 | 15.3 |
| Pene | DIN EN 1426 | mm/10 | 5 | 5 | 7 |
| Maintenance of | DIN EN 1426 | % | 56 | 50 | 58 |
| Pene | | | | | |

These results show that the bituminous composition according to the invention meets the requirements of road construction standard EN 12591, that is:
After RTFOT, the variation in BRT is 6.4° C. and therefore less than 8° C., as stipulated by the standard, contrary to that not modified by the addition of soda,
After RTFOT, Pene is maintained at 67%, which is thus greater than 60%, as stipulated by the standard, contrary to that not modified by the addition of soda,
After RTFOT+PAV, the variation in BRT is 15.3° C. and therefore less than 16° C., as stipulated by the standard, contrary to that not modified by the addition of soda,
After RTFOT+PAV, Pene is maintained at 58%, which is thus greater than 50%, as stipulated by the standard.

Moreover, as a supplement, the measurements carried out on a bitumen base modified solely by the addition of 0.194% by weight of adhesion promoter H1 (modified pitch H1) show that the stability BRT and Pene after RTFOT and after RTFOT and PAV are very similar to those obtained for the reference bitumen base.

Resistance to low temperatures, representative of the resistance to cracking was also evaluated according to standard DIN EN 14771. The results are given in table 2.

TABLE 2

| | Bituminous composition | | Bituminous composition | |
|---|---|---|---|---|
| | Reference | | Invention | |
| | | After | | After |
| RSV VR | Initial | RTFOT | Initial | RTFOT |
| T(S = 300 MPa) | −5.6° C. | −3.7° C. | −6.3° C. | −5.4° C. |
| | | (+1.9° C.) | | (+0.9° C.) |
| Value of m at | 0.317 | 0.285 | 0.311 | 0.297 |
| T(S = 300 MPa) | | | | |
| T(m = 0.3 | −6.9° C. | −2.0° C. | −7.2° C. | −5.1° C. |
| | | (+4.9° C.) | | (+2.1° C.) |
| S at | 359.67 MPa | 249.15 MPa | 334.66 MPa | 288.09 MPa |
| T(m = 0.3) | | | | |

These results show that the bituminous composition according to the invention has a lower temperature T(S=300 MPa) and a lower variation after RTFOT, compared to that not modified by the addition of soda. Similarly, the bituminous composition according to the invention has a lower temperature T(m=0.3) and a lower variation after RTFOT, as well as a lower S value at T(m=0.3) compared to that not modified by the addition of soda. All these results account for the better resistance to cracking obtained as a result of the incorporation of soda, in bituminous compositions according to the invention.

1. A bituminous composition comprising a mixture of:
a bitumen base, which represents at least 50% by weight, and preferably at least 80% by weight, and preferentially at least 90% by weight, of the total weight of the composition, and
a hydroxide XOH with X=Na or K, which represents from 0.001 to 1% by weight of the composition,
said bitumen base having an intrinsic stability S of from 1 to 2.5 and/or a peptisation level Sa from 0 to 0.6, said values S and Sa being measured according to standard ASTM D 7157-12.

2. The composition according to claim 1, wherein the bitumen base is a mixture of products resulting from visbreaking of residues of distillation under reduced pressure, said residues of distillation under reduced pressure originating from distillation under reduced pressure of atmospheric residues originating from direct atmospheric distillation of petroleum.

3. The composition according to claim 1, comprising from 0.002 to 0.5% by weight, preferably from 0.01 to 0.5% by weight of hydroxide XOH with X=Na or K, the % being % weights, relative to the total weight of the composition.

4. The composition according to claim 1, wherein the hydroxide XOH, with X=Na or K, forms particles which have a mean maximum size in the range from 10 to 100 μm, preferably in the range from 20 to 60 μm and/or which have a maximum size less than or equal to 100 μm, preferably less than or equal to 60 μm.

5. The composition according to claim 1, wherein the hydroxide XOH is soda.

6. The composition according to claim 1, wherein after RTFOT ageing (at a temperature of 163° C., for 75 minutes and under air flow of 4 litres/min), according to standard EN 12607-1, the variation in the ball and ring softening temperature of said composition, determined according to standard EN 1427, is less than 8° C. and/or the maintenance of needle penetration at 25° C. of said composition, determined according to standard EN 1426, is greater than 60%.

7. The composition according to claim 1, wherein after RTFOT ageing (at a temperature of 163° C., for 75 minutes and under air flow of 4 litres/min), according to standard EN 12607-1, the variation in the ball and ring softening temperature of said bitumen base, determined according to standard EN 1427, is greater than 8° C. and/or the maintenance of needle penetration at 25° C. of the bitumen base, determined according to standard EN 1426, is less than or equal to 60%.

8. The composition according to claim 1, wherein after RTFOT ageing (at a temperature of 163° C., for 75 minutes and under air flow of 4 litres/min)+PAV (at a temperature of 100° C., for 20 hours and at a pressure of 2100 kPa), according to standards EN 12607-1 and EN 14769, the variation in the ball and ring softening temperature of said composition, determined according to standard EN 1427, is less than 16° C. and/or the maintenance of needle penetration at 25° C. of said composition, determined according to standard EN 1426, is greater than 50%.

9. The composition according to claim 1, having a needle penetration at 25° C., determined according to standard EN 1426, which falls within the range from 5 to 80 mm/10 and/or a ball and ring softening temperature, determined according to standard EN 1427, which falls within the range from 45 to 75° C.

10. The composition according to claim 1, wherein after RTFOT ageing (at a temperature of 163° C., for 75 minutes and under air flow of 4 litres/min)+PAV (at a temperature of 100° C., for 20 hours and at a pressure of 2100 kPa), according to standards EN 12607-1 and EN 14769, the variation in the ball and ring softening temperature of the bitumen base, determined according to standard EN 1427, is greater than 16° C.

11. The composition according to claim 1, further comprising a hydrocarbonated component CH, chosen from among hydrocarbonated oils, soft-grade bitumen, fluxed bitumen, fluidified bitumen, and mixtures thereof, said hydrocarbonated component CH preferably representing at the most 10% by weight, preferentially 0.1 to 10% by weight, in a more preferred manner 0.5 to 8% by weight, and even more preferably 1 to 5% by weight, of the total weight of the composition.

12. The composition according to claim 1, further comprising an adhesion promoter, chosen from among amines, diamines, polyamines, alkyl amido amines, amidopolyamines, imidazolines, and mixtures thereof, said adhesion promoter representing 0.01 to 2% by weight, preferentially 0.05 to 1% by weight, and in an even more preferred manner 0.1 to 0.3% by weight, of the total weight of the composition.

13. A method for preparing a bituminous composition, comprising the following steps:
a—having an initial bituminous composition available comprising a bituminous base having an intrinsic stability S from 1 to 2.5 and/or a peptisation level Sa from 0 to 0.6, said values S and Sa being defined and measured according to standard ASTM D 7157-12, and
b—incorporating a hydroxide XOH with X=Na or K, in an amount such that the amount of hydroxide XOH introduced represents 0.001 to 1% by weight, of the total weight of the final bituminous composition obtained,
the initial bituminous composition comprising an amount such that said bituminous base represents at least 50% by weight, preferably at least 80% by weight, and preferably at least 90% by weight, of the total weight of the final bituminous composition obtained.

14. The method according to claim 13, wherein in step b, a hydrocarbonated composition IC comprising 15 to 50% by weight of hydroxide XOH with X=Na or K is incorporated into the initial bituminous composition, said composition IC, comprising a hydrocarbonated component CH, preferably chosen from among hydrocarbonated oils, soft-grade bitumen, fluxed bitumen, fluidified bitumen and mixtures thereof.

15. The method according to claim 14, wherein the hydroxide XOH, with X=Na or K, is present in the composition IC, in the form of particles which have a mean maximum size in the range from 10 to 100 μm, preferably in the range from 20 to 60 μm and/or which have a maximum size less than or equal to 100 μm, preferably less than or equal to 60 μm.

16. The method according to claim 1, wherein incorporation of the hydrocarbonated composition IC into the initial bituminous composition, is carried out, at a temperature in the range from 150 to 220° C., preferably in the range from 160 to 190° C. and/or with stirring in the range from 100 to 500 rpm, preferably in the range from 200 to 400 rpm, for a period of 10 to 180 minutes, preferably from 10 to 20 minutes.

17. A method for improving resistance to ageing under RTFOT (at a temperature of 163° C., for 75 minutes under air flow of 4 litres/min) according to the standard EN 1426 and/or for improving resistance to ageing under RTFOT (at a temperature of 163° C., for 75 minutes under air flow of 4 litres/min)+PAV (at a temperature of 100° C., for 20 hours and at a pressure of 2100 kPa) carried out according to standards EN 12607-1 and EN 14769 and/or for improving resistance to low temperatures of a bituminous composition which comprises a bitumen base having an intrinsic stability S from 1 to 2.5 and/or a peptisation level Sa from 0 to 0.6, said values S and Sa being measured according to standard ASTM D 7157-1, by introducing into said bituminous composition a hydroxide XOH with X=Na or K in an amount representing from 0.001 to 1% by weight, preferably from 0.002 to 0.5% by weight, and preferentially from 0.01 to 0.5% by weight, of the total weight of the bituminous composition, said bitumen base representing at least 50% by weight, preferably at least 80% by weight, and preferentially at least 90% by weight, of the total weight of the bituminous composition, the % by weight given for the bitumen base and hydroxide being calculated relative to the total weight of the bituminous composition including the hydroxide.

18. The method according to claim 17, wherein the introduction of the hydroxide XOH with X=Na or K in the bituminous composition leads, after RTFOT ageing (at a temperature of 163° C., for 75 minutes under air flow of 4 litres/min), according to the standard EN 12607-1, to a variation in the ball and ring softening temperature, determined according to standard EN 1427, of less than 8° C. and/or maintenance of needle penetration at 25° C., determined according to standard EN 1426, greater than 60%, and/or leads, after RTFOT ageing (at a temperature of 163° C., for 75 minutes under air flow of 4 litres/min)+PAV (at a temperature of 100° C., for 20 hours and at a pressure of 2100 kPa), according to the standards EN 12607-1 and EN 14769, to a variation in the ball and ring softening temperature, determined according to standard EN 1427, of less than 16° C. and/or maintenance of needle penetration at 25° C., determined according to standard EN 1426, greater than 50%.

19-20. (canceled)

21. A waterproof coating, a membrane or a seal layer prepared with a composition according to claim 1.

22. A method for preparing a mix comprising hot mixing of a composition according to claim 1 with aggregates, and possibly mineral and/or synthetic fillers.

23. A mix comprising the composition according to claim 1 mixed with aggregates, and possibly mineral and/or synthetic fillers.

24. A method for preparing an asphalt, comprising hot mixing a composition according to claim 1 with mineral and/or synthetic fillers.

25. An asphalt comprising a composition according to claim 1 mixed with aggregates, and possibly mineral and/or synthetic fillers.

26. A surface coat, a hot mix, a cold mix, a cold-poured mix, a grave-emulsion or a rolling layer, prepared with a composition according to claim 1 associated with aggregates and/or recycled milled material.
